(19) United States
(12) Patent Application Publication
(10) Pub. No.: US 2026/0311082 A1
(43) Pub. Date: Oct. 8, 2026

(54) Workforce Realignment Based on Vulnerability Factor

(71) Applicant: Dell Products L.P., Round Rock, TX (US)

(72) Inventors: Boris Shpilyuck, Ashdod (IL); Igor Dubrovsky, Beer-Sheva (IL); Nisan Haimov, Beer-Sheva (IL); Eric Young, Alexandria, VA (US)

(21) Appl. No.: 19/098,856

(22) Filed: Apr. 2, 2025

(51) Int. Cl. G06Q 10/0631

(52) U.S. Cl. CPC G06Q 10/063112

(57) ABSTRACT

A system can, for microservices, identify a vulnerability factor-based workforce selection policy that identifies respective numbers of developers and respective job grades of the respective developers that correspond to respective vulnerability factors. The system can identify respective technical complexity-based workforce selection policies that identify respective technical domains, respective numbers of developers, and corresponding respective skill levels for respective microservices of the microservices, identify respective technical complexity values for the respective microservices, determine the respective vulnerability factors for the respective microservices, and identify respective performance levels and respective expertise levels for respective developers from a workforce management system. The system can iterate over the respective microservices to assign the respective developers to the respective microservices, based on the vulnerability factor-based workforce selection policy, the respective technical complexity-based workforce selection policies, the respective technical complexity values, the respective vulnerability factors, the respective performance levels, and the respective expertise levels.

### BACKGROUND

A computer program or service can be architected through a microservices architecture, which comprises a group of intercommunicating microservices.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can, for microservices in a microservices architecture, identify a vulnerability factor-based workforce selection policy that identifies respective numbers of developers and respective job grades of the respective developers that correspond to respective vulnerability factors. The system can identify respective technical complexity-based workforce selection policies that identify respective technical domains, respective numbers of developers, and corresponding respective skill levels for respective microservices of the microservices. The system can identify respective technical complexity values for the respective microservices. The system can determine the respective vulnerability factors for the respective microservices. The system can identify respective performance levels and respective expertise levels for respective developers from a workforce management system. The system can iterate over the respective microservices to assign the respective developers to the respective microservices, based on the vulnerability factor-based workforce selection policy, the respective technical complexity-based workforce selection policies, the respective technical complexity values, the respective vulnerability factors, the respective performance levels, and the respective expertise levels.

An example method can comprise, identifying, by a system comprising at least one processor, a vulnerability factor-based workforce selection policy for microservices in a microservice architecture. The method can further comprise identifying, by the system, respective technical complexity-based workforce selection policies for respective microservices of the microservices. The method can further comprise identifying, by the system, respective technical complexity values for the respective microservices. The method can further comprise determining, by the system, the respective vulnerability factors for the respective microservices. The method can further comprise identifying, by the system, respective performance levels and respective expertise levels for respective developers from a workforce management system. The method can further comprise iterating, by the system, over the respective microservices to assign the respective developers to the respective microservices, based on the vulnerability factor-based workforce selection policy, the respective technical complexity-based workforce selection policies, the respective technical complexity values, the respective vulnerability factors, the respective performance levels, and the respective expertise levels.

An example non-transitory computer-readable medium can comprise instructions that, in response to execution, cause a system comprising a processor to perform operations. These operations can comprise ascertaining a vulnerability factor-based workforce selection policy for microservices in a microservice architecture. These operations can further comprise ascertaining respective technical complexity-based workforce selection policies for respective microservices of the microservices. These operations can further comprise ascertaining respective technical complexity values for the respective microservices. These operations can further comprise determining the respective vulnerability factors for the respective microservices. These operations can further comprise ascertaining respective performance levels and respective expertise levels for respective developers from a workforce management system. These operations can further comprise assigning the respective developers to the respective microservices, based on the vulnerability factor-based workforce selection policy, the respective technical complexity-based workforce selection policies, the respective technical complexity values, the respective vulnerability factors, the respective performance levels, and the respective expertise levels.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate workforce realignment based on vulnerability factor, in accordance with an embodiment of this disclosure;

FIG. 2 illustrates another example system architecture that can facilitate workforce realignment based on vulnerability factor, in accordance with an embodiment of this disclosure;

FIG. 3 illustrates an example process flow that can facilitate workforce realignment based on vulnerability factor, in accordance with an embodiment of this disclosure;

FIG. 4 illustrates another example process flow that can facilitate workforce realignment based on vulnerability factor, in accordance with an embodiment of this disclosure;

FIG. 5 illustrates another example process flow that can facilitate workforce realignment based on vulnerability factor, in accordance with an embodiment of this disclosure;

FIG. 6 illustrates another example process flow that can facilitate workforce realignment based on vulnerability factor, in accordance with an embodiment of this disclosure;

FIG. 7 illustrates another example process flow that can facilitate workforce realignment based on vulnerability factor, in accordance with an embodiment of this disclosure;

FIG. 8 illustrates another example process flow that can facilitate workforce realignment based on vulnerability factor, in accordance with an embodiment of this disclosure;

FIG. 9 illustrates another example process flow that can facilitate workforce realignment based on vulnerability factor, in accordance with an embodiment of this disclosure; and

FIG. 10 illustrates an example block diagram of a computer operable to execute an embodiment of this disclosure.

### DETAILED DESCRIPTION

### Overview

In a microservices environment, an application can comprise hundreds or even thousands of microservices. Some microservices can be more challenging to maintain and execute than others because of various factors, such as higher code complexity, unclear requirements, or a development workforce that lacks the needed qualifications. This can result in production issues, bugs, and frequent corrections in the existing codebase to rectify the problems.

In prior approaches, management users can use their intuition and experience to decide when certain microservices should undergo the refactoring and which engineers should be assigned to this task. However, because this is a subjective and unscientific decision, it can carry the risk of human errors, and can have other problems.

An inquiry addressed by the present techniques can involve formulating a scientific recommendation on which microservices merit modification, and which engineers should be responsible for the changes and subsequent maintenance.

The present techniques can be implemented to facilitate a vulnerability factor (VF), which can be calculated for each microservice. Some similar implementations of a vulnerability factor can be used to prioritize microservices for chaos testing. In contrast, a vulnerability factor can be implemented to prioritize microservices for refactoring, and for workforce selection. A vulnerability factor can comprise an aggregated microservice that indicates a level of vulnerability for a corresponding microservice.

In addition, an organizational workforce management system can be cross-referenced to find out the ranks and qualifications of the engineers that are responsible for the various microservices.

The higher the vulnerability factor, the more prioritized the microservice can be for the refactoring, and the higher-skilled the workforce that can be indicated for it and for the subsequent maintenance.

The present techniques can be implemented to facilitate prioritizing the selection of microservices for refactoring and finding the corresponding workforce is critical. While some managers can have good familiarity with the state of the microservices and qualifications of the workforce, their decisions regarding microservices selection for refactoring and corresponding workforce assignment to the microservices can still be prone to human mistakes.

Failure to decide on the refactoring in a microservice, or an inadequate choice of the engineers for this task and/or for maintenance of the microservice, can result in bugs in production, violations of service level agreement (SLA) contracts, and can eventually have a monetary impact on the organization.

It can be complicated to decide on a set of the most (or sufficiently) vulnerable microservices for refactoring and for workforce assignment to the microservices. A decision on the set of the most vulnerable microservices for the refactoring and on the workforce assignment can be complicated because:
There can be hundreds or even thousands of the microservices, and the prioritization for the refactoring should be done among them based on their vulnerability. But it can be difficult to quantifiably describe the vulnerability.
The contents of a satisfactory set of microservices to select can change over time as code is being developed. Therefore, according to the present techniques, the vulnerability criteria can be dynamically applied for the selection of the microservices and evolve with the code base.
There can be problems with measuring and matching the quality of the workforce against the discovered vulnerability.
Development of some microservices can involve advanced technical knowledge in areas like security, artificial intelligence (AI), networking, etc. It can be that such skill usually cannot be acquired quickly. So, there can be challenges related to how the skill of the workforce (not only quality) can be factored in to match the indicated skill within each microservice.

Therefore, to be able to prioritize the microservices for the refactoring and to allocate the workforce in optimal way, there can be a desire for a solution that addresses the above issues.

To be able to select a suitable workforce for refactoring and maintenance of the microservices, a system according to the present techniques can take into consideration two factors for each microservice-a vulnerability factor and a special technical complexity of the microservice. The higher those factors are, the more engineers with more experience and higher degree of technical expertise in the relevant areas can be indicated to work on those microservices.

A process flow of an example implementation of the present techniques can be:
1. Define a vulnerability factor-based workforce selection policy (e.g., done by a system operator).
2. Define a technical complexity-based workforce selection policy (e.g., done by the system operator).
3. Configure a special technical complexity and the level of that complexity for each relevant microservice (e.g., done by microservice owners).
4. Calculate a vulnerability factor for each microservice.
5. Fetch job grades and levels of expertise in special technical areas for the project's engineers from a workforce management system.
6. Iterate over the microservices, their vulnerability factors and technical complexities, and select the relevant workforce (e.g., a workforce with matching seniority and expertise from #5, above) for each microservice using polices in #1 and #2, above.

A vulnerability factor-based workforce selection policy can be implemented as follows. A vulnerability factor-based workforce selection policy can be defined by a system operator and can match a indicated number of engineers and their corresponding job grades (indicating seniority) based on the vulnerability factor of a microservice.

For example, the policy can be:
VF in range [0, 50)—2 engineers are indicated.
VF is in range [50, 70)—1 senior engineer and 2 engineers are indicated.
VF is in range [70, 100]—1 principal, 2 senior engineers and 2 engineers are indicated.

A technical complexity-based workforce selection policy can be implemented as follows. A technical complexity-based workforce selection policy can be defined by a system operator. For each technical domain that is associated with significant technical complexity (e.g., AI, security, etc.), the number of engineers and their expertise level in the domain can be matched against the degree of the complexity in that domain.

The expertise levels of the engineers in technical domains can be matched to corresponding technical complexities levels, and can be defined based on a range into which their grade in the domain falls.

For example, a part of the policy related to the expertise in the field of AI can be:
“Moderate degree of complexity”—1 engineer with “moderate expertise level” can be indicated. A “moderate expertise” level is achieved by having expertise grade in a range between 40 and 60.
“High degree of complexity”—1 engineer with “high expertise level” can be indicated. A “high expertise level” is achieved by having expertise grade in a range between 60 and 80.
“Critical degree of complexity”—2 engineers with “outstanding expertise level” can be indicated. An “outstanding expertise level” is achieved by having expertise grade in a range between 80 and 100.

Configuring special technical complexity for the microservices can be implemented as follows. The microservices that have special technical complexity associated with them can be marked so, and the degree of that complexity can be noted as Low, Moderate, High, Critical, etc., for example.

In some examples, microservice owners can provide this configuration, and it can also be reviewed by a system operator (or another relevant person within the organization).

For example, the configuration for a microservice can be:
AI—Moderate
Trade and Compliance—Critical

A vulnerability factor calculation according to the present techniques can be implemented as follows.

In general, a microservice can be more vulnerable when its codebase is complex, and when the developers who contribute to that codebase have a tendency to produce code with high severity issues.

The VF itself can be an aggregated numeric metric that specifies how vulnerable each microservices is, and can be based on the following factors:
Complexity of the code within the microservice;
Development profile of the engineers that contributed to the microservice's codebase; and
Historical record of issues within the microservice.

In some examples, a vulnerability factor can range between 1 and 100.

According to the present techniques, a vulnerability factor can be leveraged for ordering microservices by their vulnerability—if the microservice is more vulnerable, it can be indicated for more engineers with higher seniority for a task of refactoring/maintenance of that microservice.

The present techniques can implement fetching job grades and levels of expertise as follows. The following details per engineer can be fetched from a workforce management system that is used within an organization:
Identifier (ID) and name;
Job grade (senior, principal, etc.);
Expertise in tech domains and corresponding levels of expertise (e.g., [AI, 70], [Networking, 90]). This can be a list of 0 or more elements.

Regarding the expertise in tech domains, there can be examples where an organization measures the skill level of its workforce in different technical areas. For example, this can be through obligatory courses (from beginner level through advanced), or through optional courses that engineer was interested in and obtained a measurable qualification upon completion.

Workforce selection per microservice can be implemented as follows. A system can allow each engineer to be assigned to a maximum of K microservices based on his ranking (e.g., for doing business-related development), and to a maximum of M microservices based on his technical expertise (e.g., for serving as technical domain expert). K and M can be system input parameters, and can be defined by a system operator. If a person has more than M skills, it can be that the person's top M skills can be considered for assignment, and the rest can be discarded.

Workforce assignment to the microservices can be performed through the following steps:
Information about the engineers, such as ID, name, rank, and list of skills/grades can be fetched from a workforce management system. To help subsequent calculations, a map of ranks to engineers {rank->list of engineers} can be created. In addition, based on grades of the engineers per skill, the skill level (moderate, high, etc.) can be known, so an additional map of the skill level in technical domain to a list of engineers having that skill/level {skill_level->list of engineers} can be mapped.
The system can calculate the vulnerability factor for each microservice.
The system can order the microservices by the VF from highest to lowest and iterate over the microservices in that order.
For each microservice the technical complexity (TC) can be fetched.
For each microservice, a vulnerability factor-based workforce selection policy can be applied on its vulnerability factor to obtain an indicated number of engineers and their ranks. The indicated number of engineers can be fetched from the map of ranks-to-engineers to satisfy the ranking requirements, starting from highest ranks to lowest. If there are not enough engineers for the needed rank, but there are still engineers available for the higher ranks—they can be used (e.g., using the lowest rank among them). Each engineer that is assigned to the microservice can cause subtraction from his or her maximal K possible rank-based assignments. If the engineer with the needed rank does not exist—the process can stop, and fall back on an approach for handling the missing workforce, as described below.
For each microservice, a technical complexity-based workforce selection policy can be applied on each of its indicated technical complexities (TCs) to obtain the indicated number of engineers with appropriate level of skills. The indicated number of engineers can be fetched from the map of the skill level in a technical domain to a list of engineers having that skill/level to satisfy the skill and level requirements for each TC. If there are not enough engineers with the needed skill level for the needed TC, but there are still engineers available with a higher skill level—they can be used (e.g., by selecting those with lowest skill level among them). Each engineer that is assigned to the microservice can cause substruction from his maximal M possible technical expertise-based assignments. If the engineer with the needed skill level does not exist—the process can stop, and fall back on an approach for handling the missing workforce, described below.
If the process finishes handling the microservices and there are no unassigned engineers remaining, then a report with recommended assignment can be generated and presented to a system operator.
If the process finishes handling the microservices and there are still unassigned engineers remaining, a strategy can be applied, such as these example strategies:
   Higher ranks to more vulnerable microservices strategy—the unassigned engineers can be ordered by their ranks and assigned equally starting from the more vulnerable microservices.
   Uniform distribution of ranks to more vulnerable microservices strategy—the unassigned engineers can be randomly shuffled and assigned equally starting from the more vulnerable microservices.
   Manual assignment—a system operator can decide on the assignment of the remaining workforce.
The report with recommended assignment can be generated and presented to the system operator.
If the process fails either on the rank-based assignment or on the technical expertise-based assignment, a strategy can be applied, such as these example strategies:
   The maximal numbers K and M of rank-based assignments and technical expertise-based assignments can be increased gradually (that is, the constraints can be iteratively relaxed), and re-calculation of the workforce assignment can be iteratively performed until the process succeeds. Adjusted K and/or M values can be presented to the system operator
   A total lacking number of rank-based assignments and technical expertise-based assignments can be calculated and presented to the system operator. The system operator can manually assure that the indicated workforce is hired/brought from other projects, etc.

The present techniques can facilitate automatically performing workforce realignment that allows optimal split of the engineers between the microservices; and/or reducing the human involvement and corresponding mistakes when performing the workforce assignment.

The present techniques can facilitate improving development processes through automatic assignment of the relevant workforce to each microservice through factoring in the presented vulnerability factor and technical complexities. Having proper workforce assigned to microservices can reduce development time, lower number of defects and allow to better achieve indicated service level agreements (SLAs).

### Example Architectures

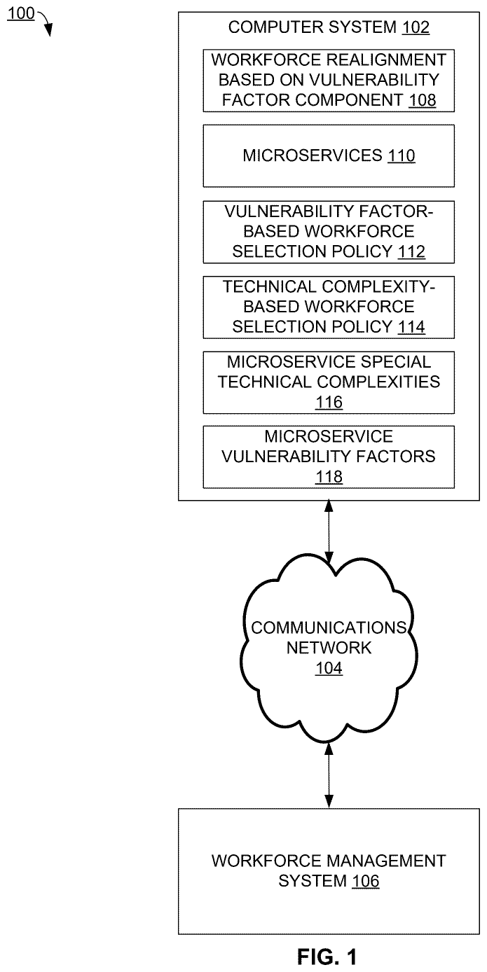

FIG. 1 illustrates an example system architecture 100 that can facilitate workforce realignment based on vulnerability factor, in accordance with an embodiment of this disclosure.

System architecture 100 comprises computer system 102, communications network 104, and workforce management system 106. In turn, computer system 102 comprises workforce realignment based on vulnerability factor component 108, microservices 110, vulnerability factor-based workforce selection policy 112, technical complexity-based workforce selection policy 114, microservice special technical complexities 116, and microservice vulnerability factors 118.

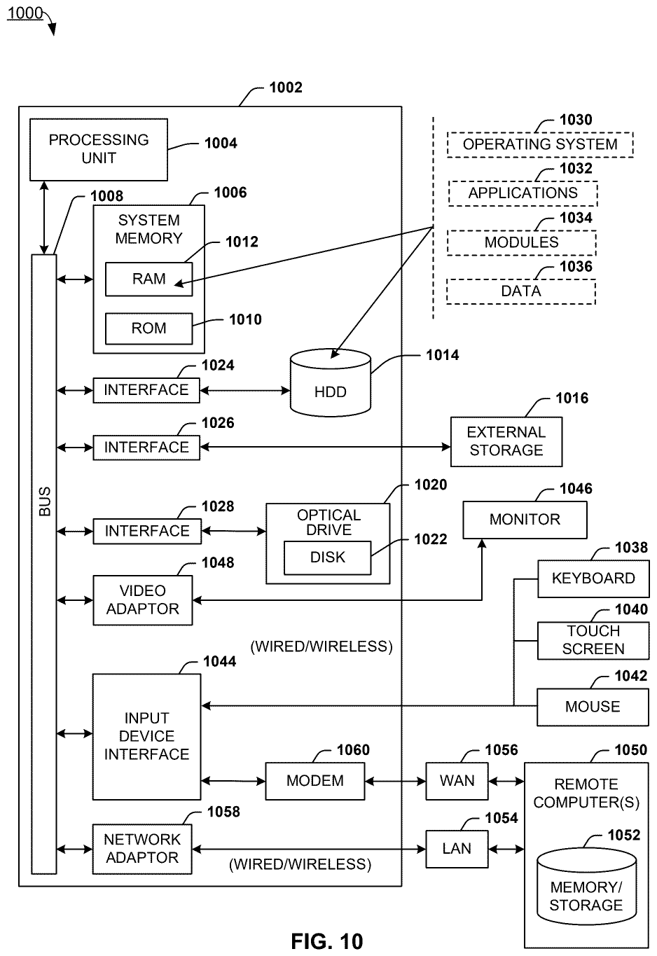

Each of computer system 102, workforce management system 106, and/or authentication server 120 (tokens) can be implemented with part(s) of computing environment 1000 of FIG. 10. Communications network 104 can comprise a computer communications network, such as the Internet.

Workforce realignment based on vulnerability factor component 108 can determine which developers (identified in workforce management system 106) to assign to develop which microservices of microservices 110. To do so, workforce realignment based on vulnerability factor component 108 can use a variety of information.

This information can include vulnerability factor-based workforce selection policy 112, technical complexity-based workforce selection policy 114, microservice special technical complexities 116, and microservice vulnerability factors 118, as well as information about the developers from workforce management system 106.

With this information, workforce realignment based on vulnerability factor component 108 can iterate over the microservices, their vulnerability factors and technical complexities, and select the relevant workforce (e.g., a workforce with matching seniority and expertise as specified) for each microservice using vulnerability factor-based workforce selection policy 112 and technical complexity-based workforce selection policy 114.

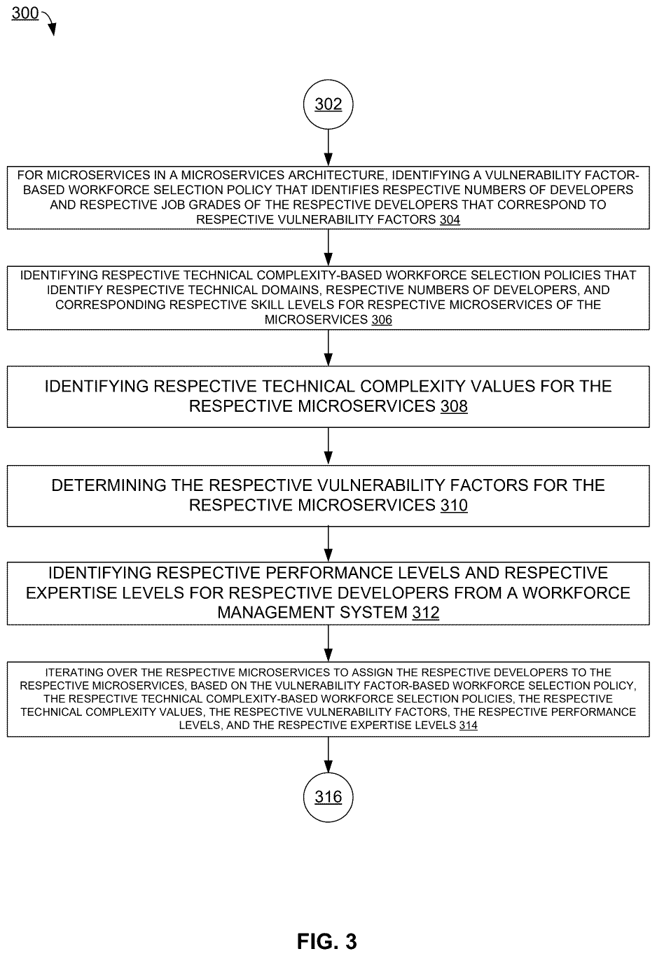

In some examples, workforce realignment based on vulnerability factor component 108 can implement part(s) of the process flows of FIGS. 3-9 to implement workforce realignment based on vulnerability factor.

It can be appreciated that system architecture 100 is one example system architecture for workforce realignment based on vulnerability factor, and that there can be other system architectures that facilitate workforce realignment based on vulnerability factor.

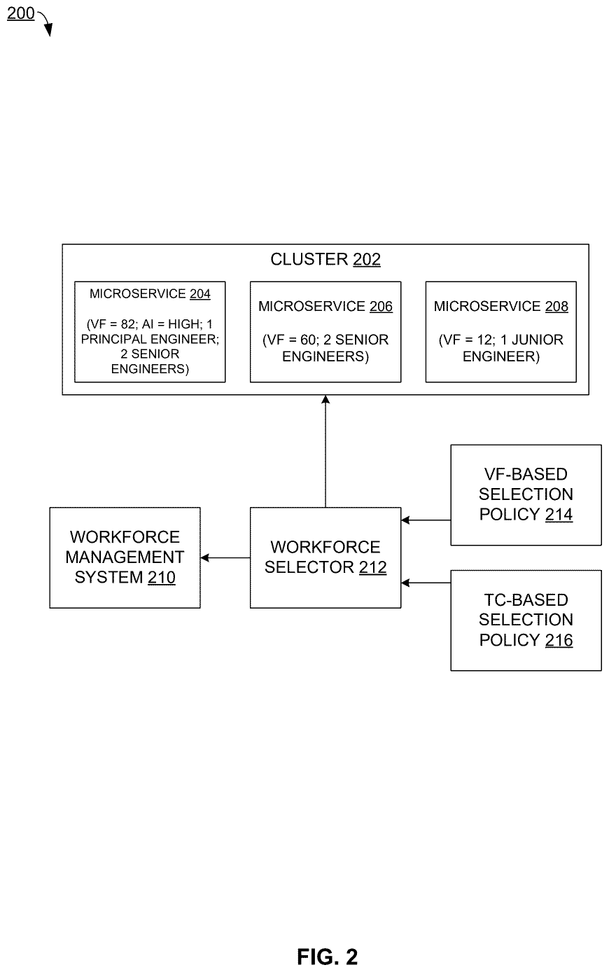

FIG. 2 illustrates another example system architecture 200 that can facilitate workforce realignment based on vulnerability factor, in accordance with an embodiment of this disclosure. In some examples, part(s) of system architecture 200 can be used by part(s) of system architecture 100 of FIG. 1 to facilitate workforce realignment based on vulnerability factor.

System architecture 200 comprises cluster 202, microservice 204 (VF=82; AI=High; 1 principal engineer; 2 senior engineers, 2 engineers with HIGH AI expertise), microservice 206 (VF=60; 2 senior engineers), microservice 208 (VF=12; 1 junior engineer), workforce management system 210, workforce selector 212, VF-based selection policy 214, and TC-based selection policy 216.

In an example, workforce selector 212 receives engineers'IDs, ranks, skills and levels from workforce management system 210. In addition, VF-based selection policy 214 and TC-based selection policy 216 are defined by the system operator. Workforce selector 212 calculates VF and TC for each microservice and uses VF-based selection policy 214 and TC-based selection policy 216 to assign the workforce accordingly to VF and TC. Microservice 204 with VF=82 is assigned one principal engineer and two senior engineers due to rank-based assignment, and two engineers with High level expertise in AI due technical expertise-based assignments. Microservice 206 and microservice 208 (with VF=60 and VF=12, respectively) do not have specific technical complexity, and are assigned two senior engineers, and one junior engineer, respectively, due to rank-based assignment.

### Example Process Flows

FIG. 3 illustrates an example process flow 300 that can facilitate workforce realignment based on vulnerability factor, in accordance with an embodiment of this disclosure. In some examples, one or more embodiments of process flow 300 can be implemented by workforce realignment based on vulnerability factor component 108 of FIG. 1, or computing environment 1000 of FIG. 10.

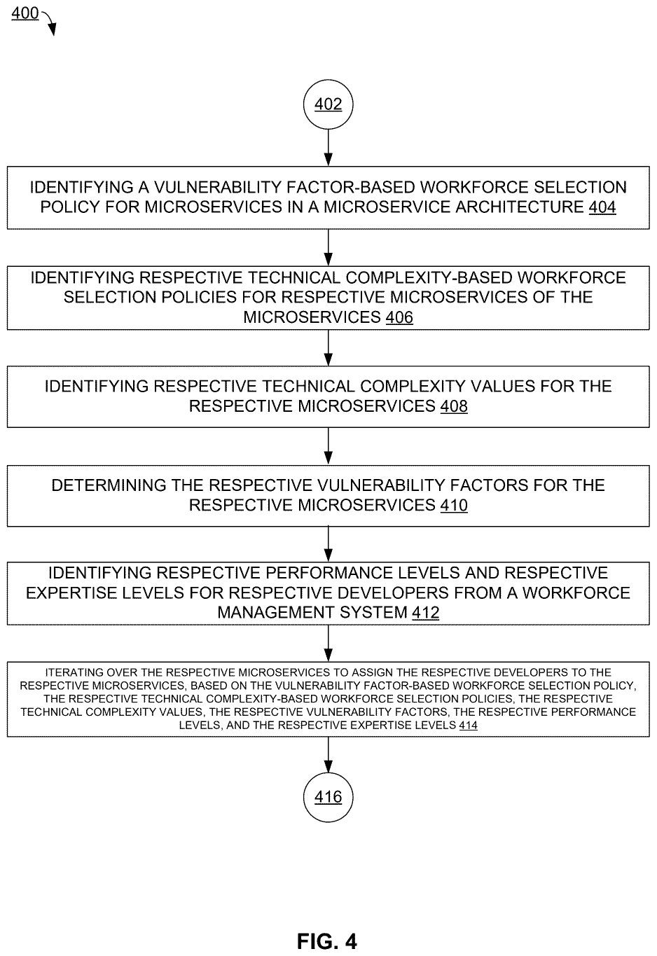

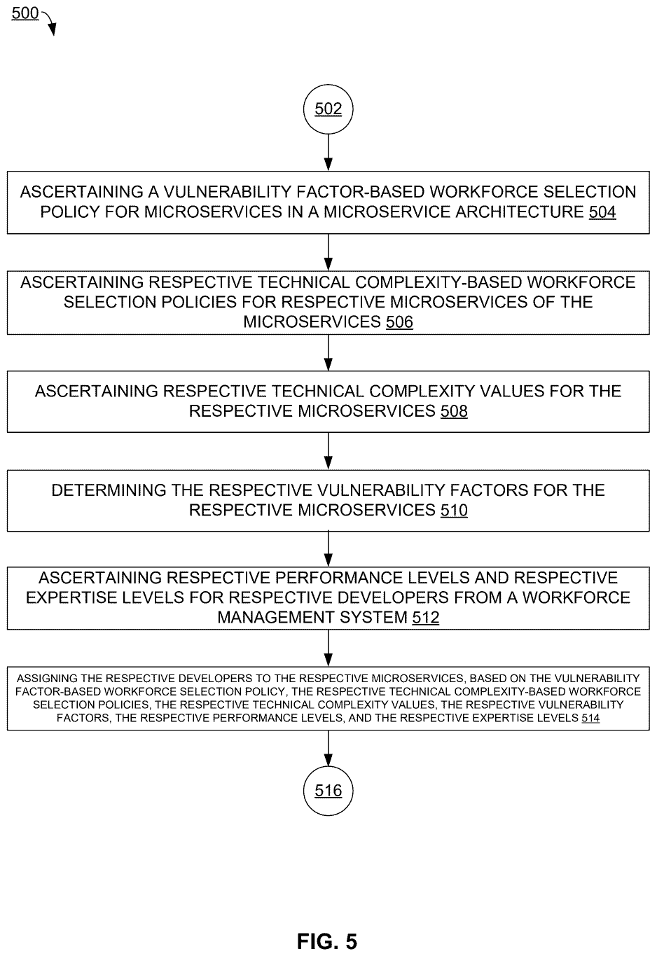

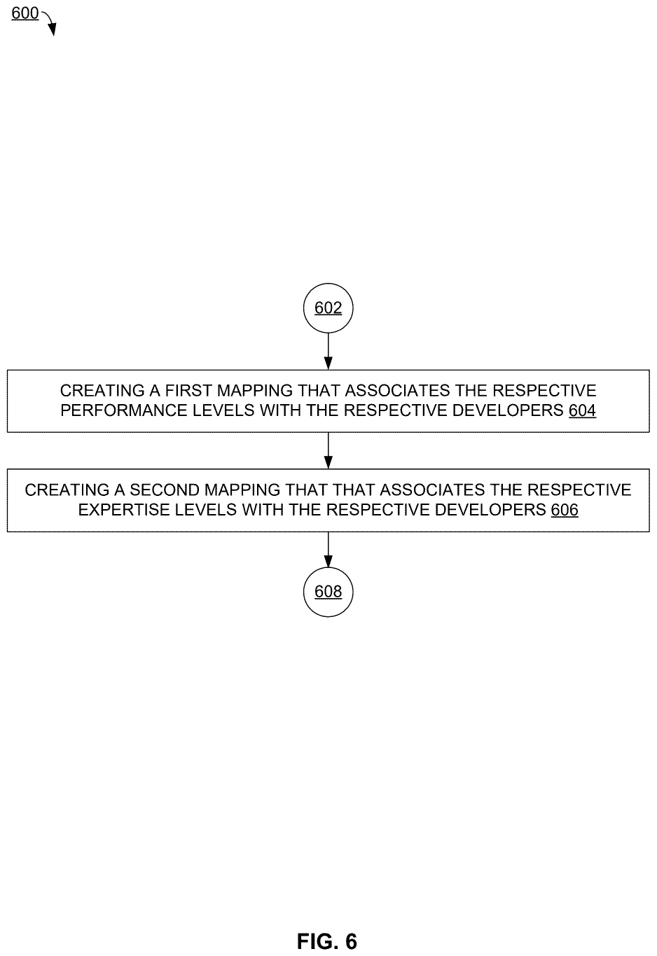

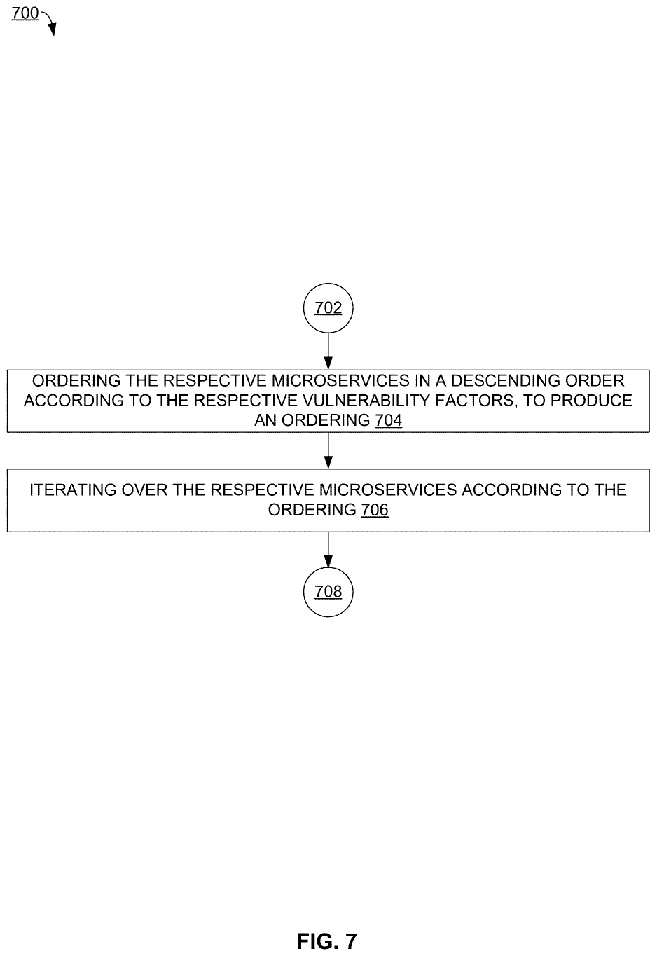

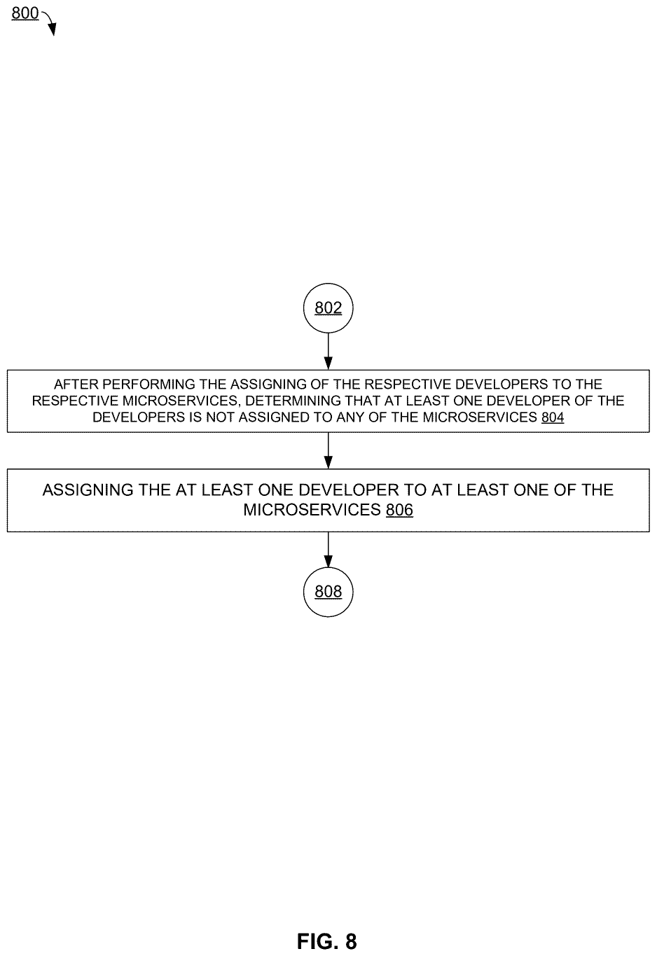

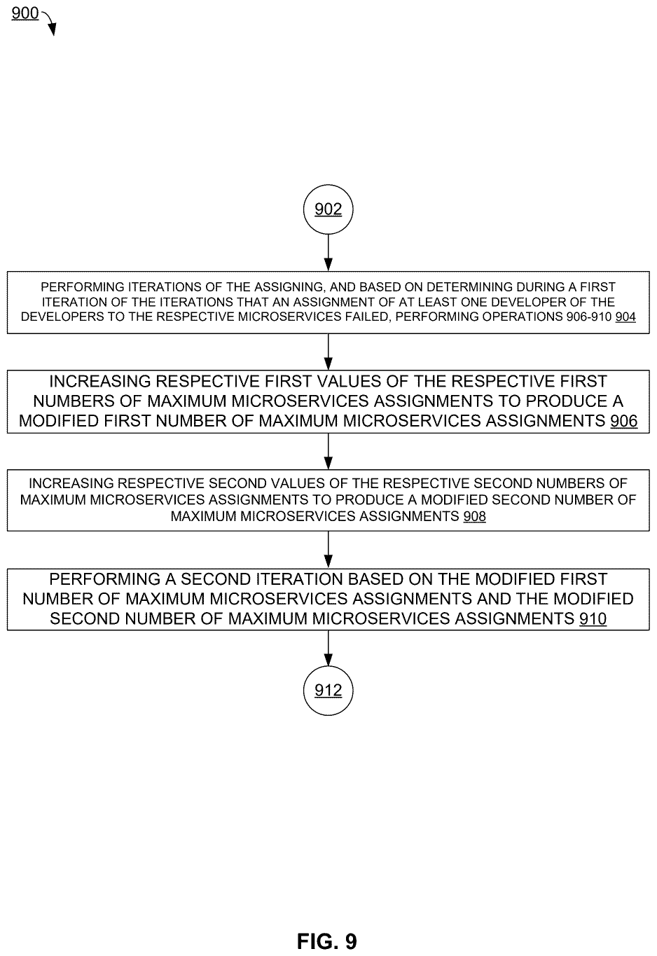

It can be appreciated that the operating procedures of process flow 300 are example operating procedures, and that there can be embodiments that implement more or fewer operating procedures than are depicted, or that implement the depicted operating procedures in a different order than as depicted. In some examples, process flow 300 can be implemented in conjunction with one or more embodiments of one or more of process flow 400 of FIG. 4, process flow 500 of FIG. 5, process flow 600 of FIG. 6, process flow 700 of FIG. 7, process flow 800 of FIG. 8, and/or process flow 900 of FIG. 9.

Process flow 300 begins with 302, and moves to operation 304.

Operation 304 depicts, for microservices in a microservices architecture, identifying a vulnerability factor-based workforce selection policy that identifies respective numbers of developers and respective job grades of the respective developers that correspond to respective vulnerability factors. This can be a vulnerability factor-based workforce selection policy as described herein.

In some examples, the vulnerability factor-based workforce selection policy is determined based on user input data. In some examples, the vulnerability factor-based workforce selection policy identifies the respective numbers of developers and the corresponding respective skill levels for respective ranges of vulnerability factors. That is, a vulnerability factor-based workforce selection policy can be implemented as follows. A vulnerability factor-based workforce selection policy can be defined by a system operator and can match a indicated number of engineers and their corresponding job grades (indicating seniority) based on the vulnerability factor of a microservice.

After operation 304, process flow 300 moves to operation 306.

Operation 306 depicts identifying respective technical complexity-based workforce selection policies that identify respective technical domains, respective numbers of developers, and corresponding respective skill levels for respective microservices of the microservices. These can be technical complexity-based workforce selection policies as described herein.

In some examples, the respective technical complexity-based workforce selection policies are determined based on user input data. That is, a technical complexity-based workforce selection policy can be defined by a system operator.

After operation 306, process flow 300 moves to operation 308.

Operation 308 depicts identifying respective technical complexity values for the respective microservices. These can be technical complexity values as described herein.

In some examples, the respective technical complexity values comprise low complexity, moderate complexity, high complexity, and critical complexity.

In some examples, multiple of the respective technical complexity values are assigned to at least one microservice of the microservices.

In some examples, the respective technical complexity values correspond to the respective technical domains.

In some examples, the respective technical complexity values are determined based on respective user input data associated with respective user accounts that are associated with ownership of the respective microservices. In some examples, the respective user input data is respective first user input data, and wherein at least one of the respective technical complexity values is determined based on second user input data associated with a second user account that differs from a first user account of the respective user accounts that is associated with the respective first user input data.

That is, configuring special technical complexity for the microservices can be implemented as follows. The microservices that have special technical complexity associated with them can be marked so, and the degree of that complexity can be noted as Low, Moderate, High, Critical, etc., for example. In some examples, microservice owners can provide this configuration, and it can also be reviewed by a system operator (or another relevant person within the organization).

After operation 308, process flow 300 moves to operation 310.

Operation 310 depicts determining the respective vulnerability factors for the respective microservices. These can be vulnerability factors as described herein.

After operation 310, process flow 300 moves to operation 312.

Operation 312 depicts identifying respective performance levels and respective expertise levels for respective developers from a workforce management system. This can comprise fetching job grades and levels of expertise in special technical areas for the project's engineers from a workforce management system.

After operation 312, process flow 300 moves to operation 314.

Operation 314 depicts iterating over the respective microservices to assign the respective developers to the respective microservices, based on the vulnerability factor-based workforce selection policy, the respective technical complexity-based workforce selection policies, the respective technical complexity values, the respective vulnerability factors, the respective performance levels, and the respective expertise levels. This can comprise determining which developers are to work on which microservices.

After operation 314, process flow 300 moves to 316, where process flow 300 ends.

FIG. 4 illustrates another example process flow 400 that can facilitate workforce realignment based on vulnerability factor, in accordance with an embodiment of this disclosure. In some examples, one or more embodiments of process flow 400 can be implemented by workforce realignment based on vulnerability factor component 108 of FIG. 1, or computing environment 1000 of FIG. 10.

It can be appreciated that the operating procedures of process flow 400 are example operating procedures, and that there can be embodiments that implement more or fewer operating procedures than are depicted, or that implement the depicted operating procedures in a different order than as depicted. In some examples, process flow 400 can be implemented in conjunction with one or more embodiments of one or more of process flow 300 of FIG. 3, process flow 500 of FIG. 5, process flow 600 of FIG. 6, process flow 700 of FIG. 7, process flow 800 of FIG. 8, and/or process flow 900 of FIG. 9.

Process flow 400 begins with 402, and moves to operation 404.

Operation 404 depicts identifying a vulnerability factor-based workforce selection policy for microservices in a microservice architecture. In some examples, operation 404 can be implemented in a similar manner as operation 304 of FIG. 3.

After operation 404, process flow 400 moves to operation 406.

Operation 406 depicts identifying respective technical complexity-based workforce selection policies for respective microservices of the microservices. In some examples, operation 406 can be implemented in a similar manner as operation 306 of FIG. 3.

After operation 406, process flow 400 moves to operation 408.

Operation 408 depicts identifying respective technical complexity values for the respective microservices. In some examples, operation 408 can be implemented in a similar manner as operation 308 of FIG. 3.

After operation 408, process flow 400 moves to operation 410.

Operation 410 depicts determining the respective vulnerability factors for the respective microservices. In some examples, operation 410 can be implemented in a similar manner as operation 310 of FIG. 3.

In some examples, the respective vulnerability factors satisfy respective criterions of susceptibility of the respective microservices to containing errors.

In some examples, the respective vulnerability factors are determined based on respective code complexities of the respective microservices, respective development profiles of respective contributors to the respective codebases of the respective microservices, and respective historical records of issues with the respective microservices.

That is, a microservice can be more vulnerable when its codebase is complex, and when the developers who contribute to that codebase have a tendency to produce code with high severity issues. The VF itself can be an aggregated numeric metric that specifies how vulnerable each microservices is, and can be based on complexity of the code within the microservice, a development profile of the engineers that contributed to the microservice's codebase, a historical record of issues within the microservice.

After operation 410, process flow 400 moves to operation 412.

Operation 412 depicts identifying respective performance levels and respective expertise levels for respective developers from a workforce management system. In some examples, operation 412 can be implemented in a similar manner as operation 312 of FIG. 3.

In some examples, the identifying of the respective performance levels and respective expertise levels for respective developers from the workforce management system is performed based on respective names of the respective developers and respective job grades of the respective developers.

In some examples, the respective expertise levels are determined based on respective courses taken by the respective developers.

That is, the present techniques can implement fetching job grades and levels of expertise as follows. The following details per engineer can be fetched from a workforce management system that is used within an organization: identifier (ID) and name; job grade (senior, principal, etc.); and/or expertise in tech domains and corresponding levels of expertise (e.g., [AI, 70], [Networking, 90]). This can be a list of 0 or more elements.

Regarding the expertise in tech domains, there can be examples where an organization measures the skill level of its workforce in different technical areas. For example, this can be through obligatory courses (from beginner level through advanced), or through optional courses that engineer was interested in and obtained a measurable qualification upon completion.

After operation 412, process flow 400 moves to operation 414.

Operation 414 depicts iterating over the respective microservices to assign the respective developers to the respective microservices, based on the vulnerability factor-based workforce selection policy, the respective technical complexity-based workforce selection policies, the respective technical complexity values, the respective vulnerability factors, the respective performance levels, and the respective expertise levels. In some examples, operation 414 can be implemented in a similar manner as operation 314 of FIG. 3.

After operation 414, process flow 400 moves to 416, where process flow 400 ends.

FIG. 5 illustrates an example process flow 500 that can facilitate workforce realignment based on vulnerability factor, in accordance with an embodiment of this disclosure. In some examples, one or more embodiments of process flow 500 can be implemented by workforce realignment based on vulnerability factor component 108 of FIG. 1, or computing environment 1000 of FIG. 10.

It can be appreciated that the operating procedures of process flow 500 are example operating procedures, and that there can be embodiments that implement more or fewer operating procedures than are depicted, or that implement the depicted operating procedures in a different order than as depicted. In some examples, process flow 500 can be implemented in conjunction with one or more embodiments of one or more of process flow 400 of FIG. 4, process flow 500 of FIG. 5, process flow 600 of FIG. 6, process flow 700 of FIG. 7, process flow 800 of FIG. 8, and/or process flow 900 of FIG. 9.

Process flow 500 begins with 502, and moves to operation 504.

Operation 504 depicts ascertaining a vulnerability factor-based workforce selection policy for microservices in a microservice architecture. In some examples, operation 504 can be implemented in a similar manner as operation 304 of FIG. 3.

After operation 504, process flow 500 moves to operation 506.

Operation 506 depicts ascertaining respective technical complexity-based workforce selection policies for respective microservices of the microservices. In some examples, operation 506 can be implemented in a similar manner as operation 306 of FIG. 3.

After operation 506, process flow 500 moves to operation 508.

Operation 508 depicts ascertaining respective technical complexity values for the respective microservices. In some examples, operation 508 can be implemented in a similar manner as operation 304 of FIG. 3.

After operation 508, process flow 500 moves to operation 510.

Operation 510 depicts determining the respective vulnerability factors for the respective microservices. In some examples, operation 510 can be implemented in a similar manner as operation 310 of FIG. 3.

After operation 510, process flow 500 moves to operation 512.

Operation 512 depicts ascertaining respective performance levels and respective expertise levels for respective developers from a workforce management system. In some examples, operation 512 can be implemented in a similar manner as operation 312 of FIG. 3.

After operation 512, process flow 500 moves to operation 514.

Operation 514 depicts assigning the respective developers to the respective microservices, based on the vulnerability factor-based workforce selection policy, the respective technical complexity-based workforce selection policies, the respective technical complexity values, the respective vulnerability factors, the respective performance levels, and the respective expertise levels. In some examples, operation 514 can be implemented in a similar manner as operation 314 of FIG. 3.

In some examples, the respective developers have respective first numbers of maximum microservices assignments based on the respective performance levels, the respective developers have respective second numbers of maximum microservices assignments based on the respective expertise levels, and the assigning of the respective developers to the respective microservices satisfies respective maximum assignment criteria that are based on the respective first numbers of maximum microservices assignments and the respective second numbers of maximum microservices assignments.

That is, workforce selection per microservice can be implemented as follows. A system can allow each engineer to be assigned to a maximum of K microservices based on his ranking (e.g., for doing business-related development), and to a maximum of M microservices based on his technical expertise (e.g., for serving as technical domain expert). K and M can be system input parameters, and can be defined by a system operator. If a person has more than M skills, it can be that the person's top M skills can be considered for assignment, and the rest can be discarded.

After operation 514, process flow 500 moves to 516, where process flow 500 ends.

FIG. 6 illustrates another example process flow 600 that can facilitate workforce realignment based on vulnerability factor, in accordance with an embodiment of this disclosure. In some examples, one or more embodiments of process flow 600 can be implemented by workforce realignment based on vulnerability factor component 108 of FIG. 1, or computing environment 1000 of FIG. 10.

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of one or more of process flow 300 of FIG. 3, process flow 400 of FIG. 4, process flow 500 of FIG. 5, process flow 700 of FIG. 7, process flow 800 of FIG. 8, and/or process flow 900 of FIG. 9.

In some examples, process flow 600 can be implemented to facilitate operation 514 of FIG. 5.

Process flow 600 begins with 602, and moves to operation 604.

Operation 604 depicts creating a first mapping that associates the respective performance levels with the respective developers. That is, information about the engineers, such as ID, name, rank, and list of skills/grades can be fetched from a workforce management system. To help subsequent calculations, a map of ranks to engineers {rank->list of engineers} can be created.

After operation 604, process flow 600 moves to operation 606.

Operation 606 depicts creating a second mapping that associates the respective expertise levels with the respective developers. That is, in addition first mapping of operation 604, based on grades of the engineers per skill, the skill level (moderate, high, etc.) can be known, so an additional map of the skill level in technical domain to a list of engineers having that skill/level {skill_level->list of engineers} can be mapped.

Then, in assigning the respective developers to the respective microservices, the indicated number of engineers can be fetched from the map of ranks-to-engineers to satisfy the ranking requirements, starting from highest ranks to lowest; and the indicated number of engineers can be fetched from the map of the skill level in a technical domain to a list of engineers having that skill/level to satisfy the skill and level requirements for each TC.

After operation 606, process flow 600 moves to 608, where process flow 600 ends.

FIG. 7 illustrates another example process flow 700 that can facilitate workforce realignment based on vulnerability factor, in accordance with an embodiment of this disclosure. In some examples, one or more embodiments of process flow 700 can be implemented by workforce realignment based on vulnerability factor component 108 of FIG. 1, or computing environment 1000 of FIG. 10.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of one or more of process flow 300 of FIG. 3, process flow 400 of FIG. 4, process flow 500 of FIG. 5, process flow 600 of FIG. 6, process flow 800 of FIG. 8, and/or process flow 900 of FIG. 9.

In some examples, process flow 700 can be implemented to facilitate operation 514 of FIG. 5.

Process flow 700 begins with 702, and moves to operation 704.

Operation 704 depicts ordering the respective microservices in a descending order according to the respective vulnerability factors, to produce an ordering. That is, the microservices can be ordered by the VF from highest to lowest, and iterated over in that order.

After operation 704, process flow 700 moves to operation 706.

Operation 706 depicts iterating over the respective microservices according to the ordering. This can comprise the iterating described with respect to operation 704.

After operation 706, process flow 700 moves to 708, where process flow 700 ends.

FIG. 8 illustrates another example process flow 800 that can facilitate workforce realignment based on vulnerability factor, in accordance with an embodiment of this disclosure. In some examples, one or more embodiments of process flow 800 can be implemented by workforce realignment based on vulnerability factor component 108 of FIG. 1, or computing environment 1000 of FIG. 10.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 300 of FIG. 3, process flow 400 of FIG. 4, process flow 500 of FIG. 5, process flow 600 of FIG. 6, process flow 700 of FIG. 7, and/or process flow 900 of FIG. 9.

In some examples, process flow 800 can be implemented to facilitate operation 514 of FIG. 5.

Process flow 800 begins with 802, and moves to operation 804.

Operation 804 depicts, after performing the assigning of the respective developers to the respective microservices, determining that at least one developer of the developers is not assigned to any of the microservices.

After operation 804, process flow 800 moves to operation 806.

Operation 806 depicts assigning the at least one developer to at least one of the microservices. That is, if developers-to-microservices assignment takes place, and there are still unassigned engineers remaining, a strategy can be applied, such as, higher ranks to more vulnerable microservices strategy—the unassigned engineers can be ordered by their ranks and assigned equally starting from the more vulnerable microservices; uniform distribution of ranks to more vulnerable microservices strategy—the unassigned engineers can be randomly shuffled and assigned equally starting from the more vulnerable microservices; and/or manual assignment—a system operator can decides on the assignment of the remaining workforce. The report with recommended assignment can be generated and presented to the system operator.

After operation 806, process flow 800 moves to 808, where process flow 800 ends.

FIG. 9 illustrates another example process flow 900 that can facilitate workforce realignment based on vulnerability factor, in accordance with an embodiment of this disclosure. In some examples, one or more embodiments of process flow 900 can be implemented by workforce realignment based on vulnerability factor component 108 of FIG. 1, or computing environment 1000 of FIG. 10.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 300 of FIG. 3, process flow 400 of FIG. 4, process flow 500 of FIG. 5, process flow 600 of FIG. 6, process flow 700 of FIG. 7, and/or process flow 800 of FIG. 8.

Where process flow 900 is implemented in conjunction with process flow 500 of FIG. 5, the respective developers have respective first numbers of maximum microservices assignments based on the respective performance levels, and the respective developers have respective second numbers of maximum microservices assignments based on the respective expertise levels.

In some examples, process flow 900 can be implemented to facilitate operation 514 of FIG. 5.

Process flow 900 begins with 902, and moves to operation 904.

Operation 904 depicts performing iterations of the assigning, and based on determining during a first iteration of the iterations that an assignment of at least one developer of the developers to the respective microservices failed, performing operations 906-910.

After operation 904, process flow 900 moves to operation 906.

Operation 906 depicts increasing respective first values of the respective first numbers of maximum microservices assignments to produce a modified first number of maximum microservices assignments.

After operation 906, process flow 900 moves to operation 908.

Operation 908 depicts increasing respective second values of the respective second numbers of maximum microservices assignments to produce a modified second number of maximum microservices assignments.

After operation 908, process flow 900 moves to operation 910.

Operation 910 depicts performing a second iteration based on the modified first number of maximum microservices assignments and the modified second number of maximum microservices assignments.

That is, in conjunction, operations 904-910 can be implemented to address a scenario where the process fails either on the rank-based assignment or on the technical expertise-based assignment. In such a scenario a strategy can be applied, such as the following example strategies. The maximal numbers K and M of rank-based assignments and technical expertise-based assignments can be increased gradually, and re-calculation of the workforce assignment can be iteratively performed until the process succeeds. Adjusted K and/or M values can be presented to the system operator

A total lacking number of rank-based assignments and technical expertise-based assignments can be calculated and presented to the system operator. The system operator can manually assure that the indicated workforce is hired/brought from other projects, etc.

After operation 910, process flow 900 moves to 912, where process flow 900 ends.

### Example Operating Environment

In order to provide additional context for various embodiments described herein, FIG. 10 and the following discussion are intended to provide a brief, general description of a suitable computing environment 1000 in which the various embodiments of the embodiment described herein can be implemented.

For example, parts of computing environment 1000 can be used to implement one or more embodiments of computer system 102, and/or workforce management system 106.

In some examples, computing environment 1000 can implement one or more embodiments of the process flows of FIGS. 3-9 to facilitate workforce realignment based on vulnerability factor.

While the embodiments have been described above in the general context of computer-executable instructions that can run on one or more computers, those skilled in the art will recognize that the embodiments can also be implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can also be practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a nonvolatile storage such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the . NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can also be connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are examples, and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### Conclusion

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches, and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
for microservices in a microservices architecture, identifying a vulnerability factor-based workforce selection policy that identifies respective numbers of developers and respective job grades of the respective developers that correspond to respective vulnerability factors;
identifying respective technical complexity-based workforce selection policies that identify respective technical domains, respective numbers of developers, and corresponding respective skill levels for respective microservices of the microservices;
identifying respective technical complexity values for the respective microservices;
determining the respective vulnerability factors for the respective microservices;
identifying respective performance levels and respective expertise levels for respective developers from a workforce management system; and
iterating over the respective microservices to assign the respective developers to the respective microservices, based on the vulnerability factor-based workforce selection policy, the respective technical complexity-based workforce selection policies, the respective technical complexity values, the respective vulnerability factors, the respective performance levels, and the respective expertise levels.

2. The system of claim 1, wherein the vulnerability factor-based workforce selection policy is determined based on user input data.

3. The system of claim 1, wherein the vulnerability factor-based workforce selection policy identifies the respective numbers of developers and the corresponding respective skill levels for respective ranges of vulnerability factors.

4. The system of claim 1, wherein the respective technical complexity-based workforce selection policies are determined based on user input data.

5. The system of claim 1, wherein the respective technical complexity values comprise low complexity, moderate complexity, high complexity, and critical complexity.

6. The system of claim 1, wherein multiple of the respective technical complexity values are assigned to at least one microservice of the microservices.

7. The system of claim 1, wherein the respective technical complexity values correspond to the respective technical domains.

8. The system of claim 1, wherein the respective technical complexity values are determined based on respective user input data associated with respective user accounts that are associated with ownership of the respective microservices.

9. The system of claim 8, wherein the respective user input data is respective first user input data, and wherein at least one of the respective technical complexity values is determined based on second user input data associated with a second user account that differs from a first user account of the respective user accounts that is associated with the respective first user input data.

10. A method, comprising:
identifying, by a system comprising at least one processor, a vulnerability factor-based workforce selection policy for microservices in a microservice architecture;
identifying, by the system, respective technical complexity-based workforce selection policies for respective microservices of the microservices;
identifying, by the system, respective technical complexity values for the respective microservices;
determining, by the system, the respective vulnerability factors for the respective microservices;
identifying, by the system, respective performance levels and respective expertise levels for respective developers from a workforce management system; and
iterating, by the system, over the respective microservices to assign the respective developers to the respective microservices, based on the vulnerability factor-based workforce selection policy, the respective technical complexity-based workforce selection policies, the respective technical complexity values, the respective vulnerability factors, the respective performance levels, and the respective expertise levels.

11. The method of claim 10, wherein the respective vulnerability factors satisfy respective criterions of susceptibility of the respective microservices to containing errors.

12. The method of claim 10, wherein the respective vulnerability factors are determined based on respective code complexities of the respective microservices, respective development profiles of respective contributors to the respective codebases of the respective microservices, and respective historical records of issues with the respective microservices.

13. The method of claim 10, wherein the identifying of the respective performance levels and respective expertise levels for respective developers from the workforce management system is performed based on respective names of the respective developers and respective job grades of the respective developers.

14. The method of claim 10, wherein the respective expertise levels are determined based on respective courses taken by the respective developers.

15. A non-transitory computer-readable medium comprising instructions that, in response to execution, cause a system comprising at least one processor to perform operations, comprising:
ascertaining a vulnerability factor-based workforce selection policy for microservices in a microservice architecture;
ascertaining respective technical complexity-based workforce selection policies for respective microservices of the microservices;
ascertaining respective technical complexity values for the respective microservices;
determining the respective vulnerability factors for the respective microservices;
ascertaining respective performance levels and respective expertise levels for respective developers from a workforce management system; and
assigning the respective developers to the respective microservices, based on the vulnerability factor-based workforce selection policy, the respective technical complexity-based workforce selection policies, the respective technical complexity values, the respective vulnerability factors, the respective performance levels, and the respective expertise levels.

16. The non-transitory computer-readable medium of claim 15, wherein the respective developers have respective first numbers of maximum microservices assignments based on the respective performance levels, wherein the respective developers have respective second numbers of maximum microservices assignments based on the respective expertise levels, and wherein the assigning of the respective developers to the respective microservices satisfies respective maximum assignment criteria that are based on the respective first numbers of maximum microservices assignments and the respective second numbers of maximum microservices assignments.

17. The non-transitory computer-readable medium of claim 15, wherein the assigning of the respective developers to the respective microservices comprises:
creating a first mapping that associates the respective performance levels with the respective developers; and
creating a second mapping that associates the respective expertise levels with the respective developers.

18. The non-transitory computer-readable medium of claim 15, wherein the assigning of the respective developers to the respective microservices comprises:
ordering the respective microservices in a descending order according to the respective vulnerability factors, to produce an ordering; and
iterating over the respective microservices according to the ordering.

19. The non-transitory computer-readable medium of claim 15, wherein the operations further comprise:
after performing the assigning of the respective developers to the respective microservices, determining that at least one developer of the developers is not assigned to any of the microservices;
assigning the at least one developer to at least one of the microservices.

20. The non-transitory computer-readable medium of claim 15, wherein the respective developers have respective first numbers of maximum microservices assignments based on the respective performance levels, wherein the respective developers have respective second numbers of maximum microservices assignments based on the respective expertise levels, and wherein the assigning of the respective developers to the respective microservices comprises:
performing iterations of the assigning, wherein based on determining during a first iteration of the iterations that an assignment of at least one developer of the developers to the respective microservices failed,
increasing respective first values of the respective first numbers of maximum microservices assignments to produce a modified first number of maximum microservices assignments,
increasing respective second values of the respective second numbers of maximum microservices assignments to produce a modified second number of maximum microservices assignments, and
performing a second iteration based on the modified first number of maximum microservices assignments and the modified second number of maximum microservices assignments.
